(19) United States
(12) Patent Application Publication
(10) Pub. No.: US 2021/0334371 A1
(43) Pub. Date: Oct. 28, 2021

(54) Malicious File Detection Technology Based on Random Forest Algorithm

(71) Applicants: Bluedon Information Security Technologies Corp., Guangzhou (CN); Bluedon Information Security Technologies Co., Ltd., Guangzhou (CN)

(72) Inventors: Zonggui Ke, Guangzhou (CN); Baoming Zhang, Guangzhou (CN); Xiaoning Qin, Guangzhou (CN)

(21) Appl. No.: 16/858,705

(22) Filed: Apr. 26, 2020

(51) Int. Cl. G06F 21/56; G06F 21/53; G06N 5/00; G06N 20/20

(52) U.S. Cl. CPC G06F 21/565; G06F 21/53; G06F 2221/033; G06N 20/20; G06N 5/003

(57) ABSTRACT

The present invention discloses a malicious file detection technology based on a random forest algorithm. In order to solve the shortcomings or defects of detecting a malicious file by using a feature matching method in the conventional art, a solution of extracting an effective feature and detecting the malicious file by using a machine learning algorithm is adopted, and thus the purpose of accurately and effectively identifying known and unknown malicious file is achieved.

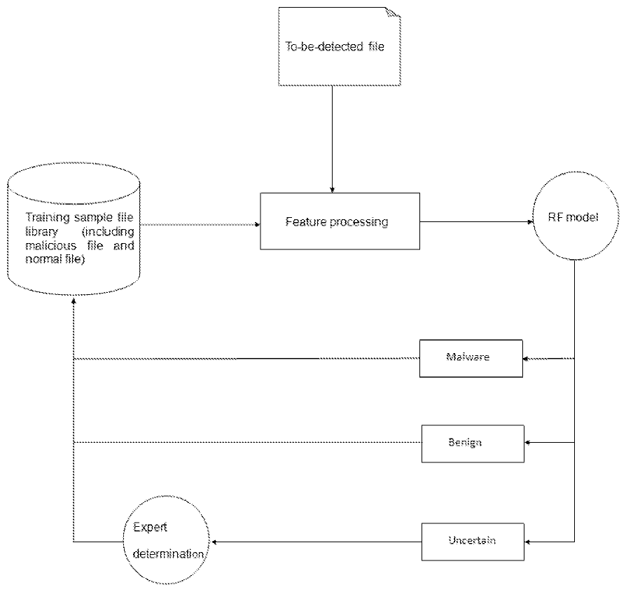

### TECHNICAL FIELD

The present invention relates to the technical field of data processing, and in particular to a malicious file detection technology based on a random forest algorithm.

### BACKGROUND

With the popularization and development of the Internet, a computer malicious program that destroys a system, tampers with a document, affects a system stability and an execution efficiency, steals information and so on is always an important problem in computer use. These malicious programs include a Trojan horse program, ransomware, spyware, etc., which may cause a great harm or a significant property loss to an enterprise or a user. Therefore, using an effective means to accurately identify a malicious file becomes a focus of computer security defense.

The current detection means mainly adopts feature code-based searching and killing, and heuristic artificial feature behavior searching and killing. The feature code-based searching and killing is to make a detection based on an antivirus software technology. Such a method cannot effectively identify an unknown malicious program, and the malicious program can only be detected when a feature code of the malicious program is added to a virus database. The heuristic artificial feature behavior searching and killing is to describe and analyze behavior features of a large number of viruses, and take a classic virus behavior feature string as a detection standard. The later mainly depends on empirical determination, so that there are high alarm leakage rate and false alarm rate.

The above rule-based detection solution can only detect a known malicious file type and fails to better identify an increasingly updated malicious file type. It is especially important to identify the unknown malicious file through a behavior.

### SUMMARY

The present invention constructs 9 types of behavior features by collecting behavior information such as file information, network information, registry information and process information of a malicious file and a normal file in a sandbox to form a feature vector. The feature vector serves as input data of a machine learning algorithm, a random forest of an integrated algorithm is selected, and a supervised detection model is established. When behavior data of a new file is generated, the model can accurately and effectively identify whether the file is malicious or not.

The technical solutions of the present invention have the following beneficial effects:

1. The alarm leakage rate and the false alarm rate are low. By collecting a dynamic behavior feature of a malicious file in a sandbox, a machine learning classifier is constructed for detection, so compared with traditional rule matching, the alarm leakage rate and the false alarm rate can be effectively reduced.

2. The model capacity identification rate is high. The identification capability of a model can be enhanced by enriching a training sample database, so that the model can discover known and unknown types of malicious files.

3. The consumption of system resources is low. Upon the completion of training, the model may be directly exported as a file; when a new sample file needs to be detected, only the new sample file is imported to the model file for detection, which greatly reduces the consumption of the system resources.

### BRIEF DESCRIPTION OF THE DRAWINGS

In order to describe the technical solutions in the embodiments of the present invention or in the conventional art more clearly, a simple introduction on the accompanying drawings which are needed in the description of the embodiments or conventional art is given below. Apparently, the accompanying drawings in the description below are merely some of the embodiments of the present invention, based on which other drawings may be obtained by those of ordinary skill in the art without any creative effort.

The sole FIGURE is a flowchart of the present invention.

### DETAILED DESCRIPTION OF THE EMBODIMENTS

Referring to the FIGURE, the technical solutions of a malicious file detection technology based on a random forest algorithm provided by the present invention are as follows:

Step 1: a malicious sample and a normal sample are collected. Disclosed malicious virus file and normal non-malicious file are respectively collected from an open-source virus website to serve as a training sample.

Step 2: a sandbox module is constructed and installed, and all behavior information of the malicious sample and the normal sample in the sandbox are collected.

Step 3: according to an action of a bottom Application Program Interface (API) of a window, 9 types of behavior features are constructed.

Step 4: sample data collected by the sandbox is processed into 9 types of behavior feature vectors to serve as a training sample feature vector.

Step 5: the processed training sample feature vector is used and input to a random forest algorithm, and a supervised classifier is learnt.

Step 6: sandbox behavior data of a program file of a to-be-detected unknown sample is collected.

Step 7: 9 types of behavior features of the to-be-detected sample are calculated to construct a to-be-detected feature vector.

Step 8: the to-be-detected sample is detected by using the trained random forest model.

Step 9: a detection result of the sample, that is, a malicious file or a normal file, is output by the random forest.

Step 10: the training sample database is enriched to improve the model detection capability.

The present invention is further described below in detail in combination with the accompanying drawings. The described detailed embodiments are merely one part of the present invention, rather than a limit for the present invention.

Specific Implementation Process:

Step 1: Disclosed malicious virus file and normal non-malicious file are respectively collected from an open-source virus website by using a crawler technology to serve as a training sample file.

Step 2: a sandbox is installed and constructed in a virtual environment, the malicious sample file and the normal sample file are respectively put into the sandbox for operation, and result data of respective operation is collected, the data including dynamic link library loading information, file operation information, registry modification information, network connection information, etc.

Step 3: according to a function of a window API function, 9 types of behavior features are constructed, respectively including “file operation type”, “network operation type”, “registry and service type”, “process thread type”, “injection type”, “driver type”, “encryption and decryption”, “message transmission”, and “other system key APIs”, and each type of features being composed of relevant API sets.

Step 4: all functions are implemented basically by invoking an API in a windows operation system. If the malicious file is not invoked with the API but is directly invoked by the system, a great number of codes need to be compiled to result in that the malicious file is more prone to be detected by an intrusion detection system. Hence, the malicious file tends to use the API to implement a series of functions. According to a function of the API, 9 types of behavior features are constructed, respectively including “file operation type”, “network operation type”, “registry and service type”, “process thread type”, “injection type”, “driver type”, “encryption and decryption”, “message transmission”, and “other system key APIs”, and each type of features being composed of relevant API sets. In the 9 types of behavior features, each type of features includes multiple APIs. APIs included in all features serve as a feature index respectively to construct a 160-dimensional feature vector. The sandbox behavior data of the sample file includes the types of invoked APIs and the number of invoking times. A statistic is made on the number of invoking times corresponding to the APIs in the 160-dimensional feature, and the feature vector of the sample file is constructed.

Step 5: the processed training sample feature vector is used and input to a random forest algorithm, and a supervised classifier is learnt. The random forest uses a concept of a bagging. A sample and a feature are drawn randomly in a putback manner to generate multiple decision-making trees; a statistic is made on decision-making results of all trees, and a type with the largest number of voting times is designated as a final output. The training sample feature vector is input to each decision-making tree of the random forest for classification, and the statistic is made on results of all trees for classification, thus training the random forest.

Step 6: a program file of a to-be-detected unknown sample is put into the sandbox for operation, and a behavior feature generated in the sandbox is collected.

Step 7: 9 types of behavior features of the to-be-detected sample are calculated to construct a to-be-detected feature vector. The processing method is the same as the step 4, and is to process the to-be-detected sample file into a 160-dimensional feature vector.

Step 8: the to-be-detected sample is detected by using the trained random forest model. The processed feature vector of the to-be-detected file is input to the trained random forest model for detection.

Step 9: a detection result of the sample, that is, a malicious file or a normal file, is output by the random forest. The random forest is an integrated algorithm composed of multiple decision-making trees selected from different features and random samples. It determines whether the to-be-detected file is the malicious file or the normal file via a manner of detecting with the multiple decision-making trees and voting.

Step 10: the training sample database is enriched. The file detected to be the malicious file at a probability of greater than 0.9 is put into a malicious file training sample database, that at a probability of smaller than 0.1 is put into a normal file training sample database, and that at a probability between 0.1-0.9 is detected artificially by a security expert, and may also be used to enrich the training sample database upon the detection.

The above gives a detailed introduction to the technical solutions of a malicious file detection technology based on a random forest algorithm provided by the present invention. In the specification, a specific example is used to describe a principle and an implementation manner of the present invention. The description on the above embodiments is merely helpful to understand a method and a core concept of the present invention. Meanwhile, those of ordinary skill in the art may make a change within a scope of the specific implementation manners and applications according to a concept of the present invention. To sum up, the content in the specification should not be understood as a limit to the present invention.

What is claimed is:

1. A malicious file detection technology based on a random forest algorithm, wherein the technology comprises the steps of constructing 9 types of behavior features by collecting behavior information such as file information, network information, registry information and process information of a malicious file and a normal file in a sandbox to form a feature vector; the feature vector serves as input data of a machine learning algorithm, a random forest of an integrated algorithm is selected, and a supervised detection model is established; and when behavior data of a new file is generated, the model can accurately and effectively identify whether the file is malicious or not.

2. The malicious file detection technology based on the random forest algorithm as claimed in claim 1, wherein constructing and installing a sandbox module, collecting all behavior information generated by the malicious sample and the normal sample in the sandbox, and processing the information into 9 types of behavior feature vectors to serve as a training sample feature vector.

3. The malicious file detection technology based on the random forest algorithm as claimed in claim 1, wherein inputting the processed training sample feature vector to the random forest algorithm, learning a supervised classifier, and calculating 9 types of behavior features of a to-be-detected sample to construct a to-be-detected feature vector.
